(19) United States
(12) Patent Application Publication
(10) Pub. No.: US 2026/0175743 A1
(43) Pub. Date: Jun. 25, 2026

(54) THERMAL MANAGEMENT SYSTEM FOR A FUEL CELL VEHICLE

(71) Applicants: HYUNDAI MOTOR COMPANY, Seoul (KR); KIA CORPORATION, Seoul (KR)

(72) Inventor: Tae Woo Ryu, Hwaseong-si (KR)

(73) Assignees: HYUNDAI MOTOR COMPANY, Seoul (KR); KIA CORPORATION, Seoul (KR)

(21) Appl. No.: 19/278,138

(22) Filed: Jul. 23, 2025

(30) Foreign Application Priority Data
Dec. 24, 2024 (KR) 10-2024-0194953

(51) Int. Cl. B60L 58/40; B60K 1/00; B60L 58/26; B60L 58/33; H01M 8/04007; H01M 8/04029; H01M 8/0432; H01M 8/04701; H01M 8/04746; H01M 10/613; H01M 10/625; H01M 10/633; H01M 10/6568; H01M 16/00

(52) U.S. Cl. CPC B60L 58/40; B60L 58/26; B60L 58/33; H01M 8/04029; H01M 8/04037; H01M 8/04373; H01M 8/04723; H01M 8/04768; H01M 10/613; H01M 10/625; H01M 10/633; H01M 10/6568; H01M 16/006; B60K 2001/005; B60L 2240/545; H01M 2220/20; H01M 2250/20; H01M 2250/402

(57) ABSTRACT

A thermal management system includes a first thermal management circuit including an electric heater for raising a temperature of stack cooling water supplied to a fuel cell stack, a second thermal management circuit including a chiller configured to facilitate heat exchange with battery cooling water supplied to a battery, a first cooling water branch line connecting a cooling water outlet of the electric heater and a first cooling water inlet of the chiller, a second cooling water branch line provided with a first end connected to a first cooling water outlet of the chiller and a second end connected to the first thermal management circuit, and the second cooling water branch line configured to supply stack cooling water discharged from the first cooling water outlet of the chiller to an upstream side of the electric heater.

### CROSS REFERENCE TO RELATED APPLICATION

The present application claims the benefit of and priority to Korean Patent Application No. 10-2024-0194953, filed Dec. 24, 2024, the entire contents of which are incorporated herein for all purposes by this reference.

### BACKGROUND

### Technical Field

The present disclosure relates to a thermal management system for a fuel cell vehicle. More particularly, the present disclosure relates to a thermal management system for a fuel cell vehicle that improves vehicle fuel efficiency by controlling temperature of a battery in a vehicle equipped with a fuel cell stack.

### Description of the Related Art

In general, electric vehicles use water-cooled batteries as their main power source, while fuel cell vehicles rely on a fuel cell stack as their primary power source.

For the batteries, efficiency decreases due to an increase in internal resistance caused by low temperatures in winter, and securing waste heat is difficult because of batteries low heat generation characteristics. Accordingly, conventional electric vehicles are equipped with a Positive Temperature Coefficient (PTC) heater or a heat pump system to provide heating in winter or to raise temperature of a battery. However, with a PTC heater, the vehicle's fuel efficiency decreases due to increased power consumption. Additionally. inclusion of a heat pump system increases the cost of the vehicle.

The fuel cell stack has high heat generation characteristics similar to engines, and the stack cooling water is managed at a higher temperature than (e.g., relative to) the battery cooling water. Accordingly, conventional fuel cell vehicles may easily utilize the waste heat of the fuel cell stack in winter and are equipped with a CATHODE OXYGEN DEPLETION (COD) heater that plays a role in dissipating the voltage of the fuel cell stack and dissipating surplus power.

Meanwhile, recent fuel cell vehicles use batteries together with the fuel cell stack to quickly supply electricity in response to changes in the vehicle's output. The batteries mounted on fuel cell vehicles are high-performance water-cooled batteries that may be used as the vehicle's main power source.

Fuel cell vehicle batteries suffer from high internal resistance when exposed to low temperatures in winter, resulting in significant power loss, which inevitably reduces the vehicle's fuel efficiency.

Accordingly, by installing a PTC heater or applying a heat pump system to thermal management circuit of the battery of a fuel cell vehicle, the temperature of the battery may be managed so as to be relatively high (e.g., as compared to when a PTC heater or heat pump system is not installed) even in winter, thereby reducing the power loss of the battery due to an increase in the internal resistance of the battery.

However, the PTC heater does not significantly improve the vehicle's fuel efficiency because it causes additional power consumption, while the heat pump system is a factor in increasing vehicle costs and increasing the number of components included in the vehicle.

The foregoing is intended merely to aid in the understanding of the background of the present disclosure. Thus, the presence of the above provided information in the Background section is not intended as an acknowledgement that any of the information provided above in the Background section falls within the purview of the related art that is already known to those of ordinary skill in the art.

### SUMMARY

The present disclosure has been made keeping in mind the above problems occurring in the related art and is intended to provide a thermal management system for a fuel cell vehicle capable of appropriately managing temperature of a battery, which is a main power source, without using a conventional PTC heater or heat pump system.

The objectives of the present disclosure are not limited to the objectives mentioned above, and other objectives not mentioned above should be clearly understood by those of ordinary skill in the art from the description below.

In order to achieve the objectives of the present disclosure as described above, there may be provided a thermal management system for a fuel cell vehicle. The thermal management system may include: a first thermal management circuit including an electric heater for raising a temperature of stack cooling water supplied to a fuel cell stack; a second thermal management circuit including a chiller configured to facilitate heat exchange with battery cooling water supplied to a battery; a first cooling water branch line connecting a cooling water outlet of the electric heater and a first cooling water inlet of the chiller; a second cooling water branch line provided with a first end connected to a first cooling water outlet of the chiller and a second end connected to the first thermal management circuit. the second cooling water branch line may be configured to supply stack cooling water discharged from the first cooling water outlet of the chiller to an upstream side of the electric heater.

According to an embodiment of the present disclosure, the first thermal management circuit may include a temperature control valve disposed upstream of the electric heater. The temperature control valve is configured to receive the stack cooling water discharged from the first cooling water outlet of the chiller through the second cooling water branch line and discharge it toward a cooling water inlet of the electric heater.

In addition, the temperature control valve may include: a first port connected to the second end of the second cooling water branch line; and a second port connected to the cooling water inlet of the electric heater, An opening amount of the first port of the temperature control valve may be determined by a controller on the basis of a difference between a temperature of the battery and a set target temperature of the battery.

Specifically, based on the temperature of the stack cooling water discharged from the fuel cell stack being higher than the temperature of the battery, the controller may be configured to determine the opening amount of the first port of the temperature control valve on the basis of the difference between the temperature of the battery and the target temperature of the battery.

In addition, based on the temperature of the battery being lower than the target temperature of the battery, and the temperature of the stack cooling water discharged from the fuel cell stack being lower than the temperature of the battery, the controller may be configured to control the first port of the temperature control valve to a closed mode until just before the temperature of the stack cooling water discharged from the fuel cell stack becomes higher than the temperature of the battery.

In addition, based on the temperature of the battery being lower than the target temperature of the battery, and the temperature of the stack cooling water discharged from the fuel cell stack being higher than the temperature of the battery, the controller may be configured to control the first port of the temperature control valve to be in an open mode.

In addition, the temperature control valve may further include: a third port connected to a cooling water outlet of the electric heater through a fourth stack cooling water line; and a fourth port connected to a cooling water outlet of the fuel cell stack through a second stack cooling water line.

In addition, the chiller may include: a second cooling water inlet connected to a cooling water outlet of the battery; a second cooling water outlet connected to a cooling water inlet of the battery; and a chiller body configured to facilitate heat exchange between the battery cooling water introduced through a second cooling water inlet of the chiller and the stack cooling water introduced through the first cooling water inlet of the chiller.

In addition, the first cooling water branch line may be installed with a three-way valve, wherein the three-way valve may include: a first port connected to a third cooling water branch line branched off from the second stack cooling water line; a second port connected to the cooling water outlet of the electric heater; and a third port connected to the first cooling water inlet of the chiller.

In addition, the controller may be configured to supply either one or both of the stack cooling water discharged from the fuel cell stack and the stack cooling water discharged from the electric heater to the first cooling water inlet of the chiller by controlling the opening amounts of the first port and the third port of the three-way valve.

According to an embodiment of the present disclosure, a thermal management system may include: a first thermal management circuit including an electric heater configured to increase a temperature of stack cooling water supplied to a fuel cell stack; a second thermal management circuit including a chiller configured to facilitate heat exchange with battery cooling water supplied to a battery; a first cooling water branch line connecting a cooling water outlet of the electric heater and a first cooling water inlet of the chiller; and a second cooling water branch line provided with a first end connected to a first cooling water outlet of the chiller and a second end connected to the first thermal management circuit. The second cooling water branch line may be configured to supply stack cooling water discharged from the chiller to an upstream side of the electric heater.

In addition, the first thermal management circuit includes a temperature control valve disposed upstream of the electric heater, the temperature control valve configured to receive the stack cooling water discharged from the chiller.

In addition, the temperature control valve may be a five way valve.

In addition, the temperature control valve may include a first port connected to the second end of the second cooling water branch line, and a second port connected to the cooling water inlet of the electric heater. An opening amount of the first port of the temperature control valve may be determined by a controller on the basis of a difference between a temperature of the battery and a set target temperature of the battery.

In addition, the chiller may include a second cooling water inlet connected to a cooling water outlet of the battery, a second cooling water outlet connected to a cooling water inlet of the battery, and a chiller body configured to facilitate heat exchange between the battery cooling water introduced through a second cooling water inlet of the chiller and the stack cooling water introduced through the first cooling water inlet of the chiller.

According to an embodiment of the present disclosure, a thermal management system may include: a first thermal management circuit including an electric heater configured to increase a temperature of stack cooling water supplied to a fuel cell stack; a second thermal management circuit including a chiller configured to facilitate heat exchange with battery cooling water supplied to a battery; a first cooling water branch line connecting the electric heater and the chiller; and a second cooling water branch line provided with a first end connected to the chiller and a second end connected to the first thermal management circuit, the second cooling water branch line configured to supply stack cooling water discharged from the chiller to an upstream side of the electric heater.

In addition, the first thermal management circuit may include a temperature control valve disposed upstream of the electric heater, the temperature control valve configured to receive the stack cooling water discharged from the chiller.

In addition, the temperature control valve may be a five way valve.

In addition, the temperature control valve may include a first port connected to the second cooling water branch line, and
a second port connected to the cooling water inlet of the electric heater. An opening amount of the first port of the temperature control valve is determined by a controller on the basis of a difference between a temperature of the battery and a set target temperature of the battery.

As described above, the present disclosure provides the following effects.

First, the temperature of the battery may be raised or increased using the waste heat of the fuel cell stack and the cathode oxygen depletion (COD) heater of the stack cooling circuit without having a separate heater in the battery cooling circuit.

Second, a thermal management system according to the present disclosure may suppress an increase in the internal resistance of the battery due to the influence of the outside (e.g., outdoor) temperature in winter, prevent power loss due to the increase in the internal resistance of the battery, and as a result, improve the fuel efficiency of the vehicle.

Third, in a thermal management system according to the present disclosure, there is no need to install a separate heater in the battery cooling circuit, which may lead to cost reduction.

The effects of the present disclosure are not limited to those described above, and other effects not mentioned may also be readily recognized by those of ordinary skill in the art from the description below.

### BRIEF DESCRIPTION OF THE DRAWINGS

The above and other objectives, features, and other advantages of the present disclosure should be more clearly understood from the following detailed description when taken in conjunction with the accompanying drawings, in which:

FIG. 1 is a diagram illustrating a thermal management system for a fuel cell vehicle according to one embodiment of the present disclosure;

FIG. 2 is a diagram illustrating a cooling water flow passing through a chiller in the thermal management system of a fuel cell vehicle according to one embodiment of the present disclosure;

FIG. 3 is a flow chart illustrating a thermal management method of the fuel cell vehicle according to one embodiment of the present disclosure; and

FIG. 4 is a diagram illustrating a thermal management system of a fuel cell vehicle according to another embodiment of the present disclosure.

### DETAILED DESCRIPTION

Hereinafter, embodiments of the present disclosure are described with reference to the attached drawings. The items included in the attached drawings are schematically illustrated to easily explain the embodiments of the present disclosure and may differ from the form actually implemented.

In addition, in the present disclosure, terms such as “first” and “second” may be used to describe various components, but the components are not limited by the terms. The terms are used for the purpose of distinguishing one component from other components. For example, within a range not departing from the scope of rights according to the concept of the present disclosure, a first component may be referred to as a second component, and the second component may be referred to as the first component. When a component, unit, controller, device, element, apparatus or the like of the present disclosure is described as having a purpose or performing an operation, function, or the like, the component, unit, controller, device, element, or apparatus should be considered herein as being “configured to” meet that purpose or perform that operation or function. Each component, unit, controller, device, element, apparatus, and the like may separately embody or be included with a processor and a memory, such as a non-transitory computer readable media, as part of the apparatus.

In a case where a high-power water-cooled battery is mounted in a fuel cell vehicle, the battery may be used as a main power source of the vehicle. Accordingly, thermal management of the battery is necessary to improve the fuel efficiency and the driving range of the vehicle.

When the battery is exposed to a low-temperature environment in winter, the internal resistance of the battery increases, which increases power loss and reduces the vehicle's fuel efficiency. Therefore, it is necessary to reduce power loss according to temperature of the battery by appropriately managing the temperature of the battery using a cooling water circuit (or cooling circuit) for thermal management of the battery.

When a PTC heater is mounted or included in the battery cooling circuit as in other heat pump systems, separate from the present disclosure, in order to suppress the increase in internal resistance of the battery in winter, the increase in the internal resistance of the battery and power loss may be reduced. However, the PTC heater causes additional power loss, which limits and prevents significant improvement in fuel efficiency. In addition, the heat pump system is a factor in escalating vehicle costs and increasing the size of the thermal management system.

Accordingly, the present disclosure reduces an increase in internal resistance and power loss of the battery by appropriately managing the temperature of the battery without applying or including a PTC heater or a heat pump system.

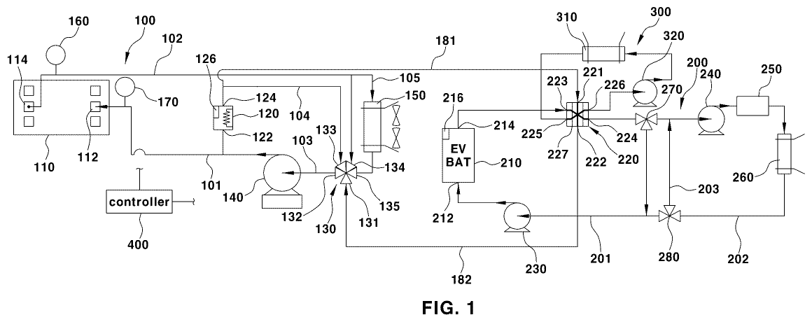

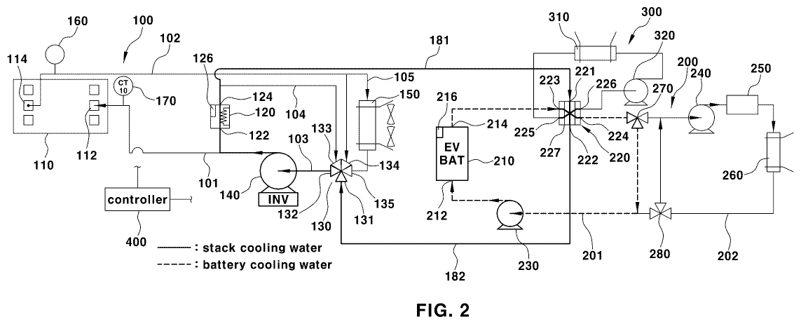

The accompanying FIG. 1 is a diagram illustrating a thermal management system for a fuel cell vehicle according to one embodiment of the present disclosure. FIG. 2 is a diagram illustrating a cooling water flow passing through a chiller in the thermal management system of a fuel cell vehicle according to one embodiment of the present disclosure.

As illustrated in FIG. 1, the thermal management system of a fuel cell vehicle according to one embodiment of the present disclosure includes a first thermal management circuit 100, which includes a fuel cell stack 110, a cathode oxygen depletion (COD) heater 120, and a temperature control valve 130. The thermal management system also includes a second thermal management circuit 200, which includes a battery 210 and a chiller 220.

The fuel cell stack 110 generates electric energy by electrochemical reaction and, like an engine, has high heat generation characteristics. Temperature control is performed for the fuel cell stack 110 using cooling water circulating in the first thermal management circuit 100. The first thermal management circuit 100 is a cooling water circuit in which cooling water (e.g., stack cooling water) for thermal management of a fuel cell stack 110 is circulated and is also referred to as a “stack cooling circuit”.

The stack cooling water absorbs heat from the fuel cell stack 110 or supplies heat to the fuel cell stack 110 as it passes through the fuel cell stack 110. Generally, the stack cooling water discharged from the fuel cell stack 110 is managed to be at a higher temperature than cooling water discharged from the battery 210 because it absorbs waste heat from the fuel cell stack 110.

The COD heater 120 is for selectively raising the temperature of the stack cooling water supplied to the fuel cell stack 110 and is disposed upstream of the cooling water inlet 112 of the fuel cell stack 110 in the first thermal management circuit 100. The COD heater 120 is driven or powered by consuming the output power or surplus power of the fuel cell stack 110. For example, the COD heater 120 may heat the cooling water using the power of the fuel cell stack (110) that remains after being used in the vehicle or the power of the fuel cell stack (110) that is left for charging the battery (210). Here, the COD heater (120) may be referred to as an “electric heater”.

The first thermal management circuit 100 includes a first cooling water pump 140 for pressurized transportation and circulation of the cooling water, a first radiator 150 for cooling the stack cooling water, and a plurality of stack cooling water lines 101, 102, 103, 104, and 105.

The first cooling water pump 140 is configured to discharge and transport the pressurized cooling water upstream of the fuel cell stack 110 and upstream of the COD heater 120. Specifically, the first cooling water pump 140 pressurizes and transports the stack cooling water toward the cooling water inlet 112 of the fuel cell stack 110 and the cooling water inlet 122 of the COD heater 120.

The first radiator 150 is configured to cool the stack cooling water through heat exchange with the outside air. The stack cooling water, which is heated while passing through the fuel cell stack 110, is cooled by exchanging heat with the outside air as it passes through the first radiator 150.

The first stack cooling water line 101 of the first thermal management circuit 100 connects the cooling water inlet 112 of the fuel cell stack 110 and the discharge port of the first cooling water pump 140 so that the cooling water may flow. The stack cooling water discharged from the first cooling water pump 140 is supplied to the fuel cell stack 110 through the first stack cooling water line 101.

The second stack cooling water line 102 connects the cooling water outlet 114 of the fuel cell stack 110 and the temperature control valve 130. The temperature control valve 130 is a five-way valve having a first port 131, a second port 132, a third port 133, a fourth port 134, and a fifth port 135. The second stack cooling water line 102 is connected to the fourth port 134 of the temperature control valve 130.

The second port 132 of the temperature control valve 130 is connected to the inlet of the first cooling water pump 140. The second port 132 of the temperature control valve 130 is connected to the inlet of the first cooling water pump 140 through the third stack cooling water line 103.

The fourth stack cooling water line 104 is configured to connect the first stack cooling water line 101 and the third port 133 of the temperature control valve 130. The fourth stack cooling water line 104 includes a first end branched off and extended from the first stack cooling water line 101 and a second end connected to the third port 133 of the temperature control valve 130. A COD heater 120 is installed at or along the fourth stack cooling water line 104.

The stack cooling water discharged from the first cooling water pump 140 may be supplied to the fuel cell stack 110 through the first stack cooling water line 101 and may be supplied to the COD heater 120 through the fourth stack cooling water line 104.

The fifth stack cooling water line 105 is configured to connect the second stack cooling water line 102 and the fifth port 135 of the temperature control valve 130. The fifth stack cooling water line 105 includes a first end branched off and extending from the second stack cooling water line 102, and a second end connected to the fifth port 135 of the temperature control valve 130. The first radiator 150 is installed along the fifth stack cooling water line 105.

The stack cooling water discharged from the fuel cell stack 110 may be supplied to the fourth port 134 of the temperature control valve 130 through the second stack cooling water line 102. It may also be supplied to the fifth port 135 of the temperature control valve 130 through the first radiator 150 via the fifth stack cooling water line 105.

The electronic control components such as the COD heater 120, the first cooling water pump 140, and the temperature control valve 130 are controlled by a controller 400 that is equipped or disposed in the vehicle. The controller 400 may perform overall control of the thermal management system and include at least two control units. The controller 400 may include a first control unit for controlling the first thermal management circuit 100, a second control unit for controlling the second thermal management circuit 200, a third control unit for controlling a refrigerant circuit 300, and the like.

The controller 400 may control the temperature control valve 130 on the basis of signals received from the first temperature sensor 160 and the second temperature sensor 216. The first temperature sensor 160 is for measuring the temperature of the stack cooling water discharged from the fuel cell stack 110, and the second temperature sensor 216 is for measuring the temperature of the battery 210. The first temperature sensor 160 is configured to measure the temperature of the stack cooling water discharged from the fuel cell stack 110 to the second stack cooling water line 102. The second temperature sensor 216 may be built into the battery 210 or may be disposed on the side of the cooling water outlet 214 of the battery 210. In addition, a third temperature sensor 170 may be provided upstream of the fuel cell stack 110 to measure the temperature of the stack cooling water flowing into the cooling water inlet 112 of the fuel cell stack 110.

The temperature control valve 130 is for controlling the flow rate of the stack cooling water flowing from the first thermal management circuit 100 to each of the stack cooling water lines 101, 102, 103, 104, and 105 and may control the temperature of the fuel cell stack 110 by controlling the opening amount or degree of the ports 131, 132, 133, 134, and 135. For example, by controlling the opening amount or opening degree of the third port 133, the flow rate of the stack cooling water passing through the COD heater 120 may be controlled, thereby controlling the temperature of the fuel cell stack 110. In addition, by controlling the opening amount of the fifth port 135, the flow rate of the stack cooling water passing through the first radiator 150 may be controlled, thereby controlling the temperature of the fuel cell stack 110.

The temperature control valve 130 may receive stack cooling water discharged from the first cooling water outlet 222 of the chiller 220 through the second cooling water branch line 182 and discharge it to the cooling water inlet 122 of the COD heater 120 (see FIG. 2).

The present disclosure may control the temperature of the battery 210 disposed in a second thermal management circuit 200 by controlling the opening amount of the temperature control valve 130.

The battery 210 may be the main power source of the vehicle and its temperature needs to be controlled to minimize its power loss. In summer when the outside temperature is high, the battery 210 may be cooled using refrigerant circulating in the refrigerant circuit 300. In winter when the outside temperature is low, the battery 210 may be heated using the stack cooling water circulating in the first heat management circuit 100. The refrigerant is a heat exchange medium used in an air conditioning device of the vehicle. The refrigerant may optionally perform heat exchange with the battery cooling water and cool the battery cooling water through heat exchange with the battery cooling water.

In order to control the temperature of the battery 210 using the stack cooling water, the first cooling water branch line 181 branched off and extending from the fourth stack cooling water line 104 is connected to the chiller 220 of the second thermal management circuit 200. In addition, the second cooling water branch line 182 is connected and extends between the chiller 220 and the temperature control valve 130.

Specifically, the first cooling water branch line 181 includes a first end branched off and extending from the fourth stack cooling water line 104 and a second end connected to the first cooling water inlet 221 of the chiller 220. The second cooling water branch line 182 includes a first end connected to the first cooling water outlet 222 of the chiller 220 and a second end connected to the first port 131 of the temperature control valve 130. The stack cooling water discharged from the first cooling water outlet 222 of the chiller 220 may be supplied to the upstream side of the COD heater 120 through the second cooling water branch line 182 and the temperature control valve 130.

The first thermal management circuit 100 and the second thermal management circuit 200 are connected through the first cooling water branch line 181 and the second cooling water branch line 182, so that the stack cooling water heated in the COD heater 120 may exchange heat with the battery cooling water through the chiller 220.

The battery cooling water is the cooling water for temperature control and management of the battery 210 and circulates through the second thermal management circuit 200. The battery cooling water may heat up the battery 210 or cool the battery 210 while circulating through the second thermal management circuit 200. In addition, the battery cooling water may absorb the waste heat of a power electronics (PE) module 250 or cool the PE module 250. The second thermal management circuit 200 is a cooling water circuit in which the battery cooling water for thermal management of the battery 210 is circulated and is also referred to as a “battery cooling circuit” in other words.

The second thermal management circuit 200 includes a first battery cooling water line 201, a second battery cooling water line 202, and a third battery cooling water line 203.

The first battery cooling water line 201 is a cooling water line having a closed loop structure and includes, disposed therealong, a battery 210, a chiller 220, a first three-way valve 270, and a second cooling water pump 230.

The second battery cooling water line 202 includes a first end connected to one port of the first three-way valve 270 and a second end connected to the first battery cooling water line 201. The second end of the second battery cooling water line 202 is connected upstream of the second cooling water pump 230.

The second battery cooling water line 202 is equipped with or includes a third cooling water pump 240, a PE module 250, a second radiator 260, and a second three-way valve 280. The PE module 250 is disposed downstream of the second cooling water pump 230 and upstream of the second radiator 260. The PE module 250 includes a motor for driving the vehicle and an inverter for controlling the current of the motor.

The third battery cooling water line 203 is configured to connect one port of the second three-way valve 280 to an upstream side of the third cooling water pump 240.

Meanwhile, the chiller 220 includes a second cooling water inlet 223 connected to the cooling water outlet 214 of the battery 210, a second cooling water outlet 224 connected to the cooling water inlet 212 of the battery 210, a refrigerant inlet 225 and a refrigerant outlet 226 connected to the refrigerant circuit 300, and a chiller body 227 in which heat exchange of the working fluid is performed.

The working fluid includes the stack cooling water, the battery cooling water, and the refrigerant. At least two working fluids among the stack cooling water, the battery cooling water, and the refrigerant undergo heat exchange inside the chiller body 227. With reference to FIG. 2, the stack cooling water flowing into the first cooling water inlet 221 and the battery cooling water flowing into the second cooling water inlet 223 exchange heat with each other inside the chiller body 227.

The second cooling water outlet 224 of the chiller 220 is connected to the cooling water inlet 212 of the battery 210 through the first three-way valve 270 and the second cooling water pump 230.

The refrigerant circuit 300 includes a compressor 320 and a condenser 310. The refrigerant inlet 225 of the chiller 220 is connected to the outlet of the condenser 310, and the refrigerant outlet 226 of the chiller 220 is connected to the inlet of the compressor 320. The refrigerant that has passed through the condenser 310 may be introduced into the refrigerant inlet 225, pass through the chiller body 227, and then be discharged through the refrigerant outlet 226. The refrigerant discharged from the refrigerant outlet 226 may flow toward the inlet of the compressor 320. When the stack cooling water is supplied to the first cooling water inlet 221 of the chiller 220 to raise the temperature of the battery 210, the compressor 320 may not be driven and the refrigerant may not be circulated in the refrigerant circuit 300.

A thermal management system according to the present disclosure controls the amount of heat (e.g., energy) supplied from the stack cooling water to the chiller 220 of the second heat management circuit 200 through the temperature control valve 130 of the first heat management circuit 100, thereby controlling the amount of heat of stack cooling water transferred to the battery cooling water through the chiller 220.

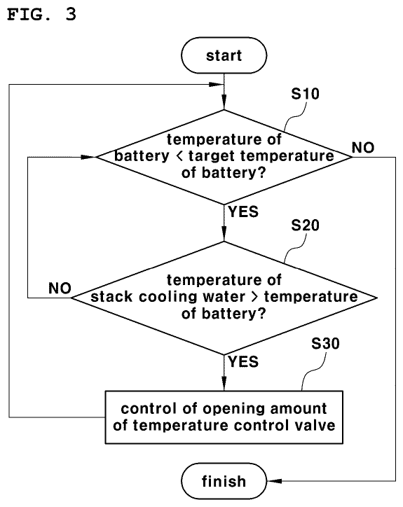

FIG. 3 is a flow chart illustrating a thermal management method for a fuel cell vehicle according to one embodiment of the present disclosure.

With reference to FIG. 3, to control the temperature of the battery 210, first, in step S10, the controller 400 compares the temperature of the battery 210 with a set target temperature of the battery. At this time, the temperature of the battery 210 is a real-time temperature. The target temperature of the battery may be set to a temperature value that may reduce the deterioration of the battery 210 while suppressing the increase in the internal resistance of the battery 210 in order to optimize the efficiency and durability of the battery 210.

In general, as the temperature of the battery 210 is raised or increases, a chemical reaction occurring in the battery becomes faster, which improves efficiency, but side reactions are also accelerated as the temperature of the battery 210 is raised. Therefore, the target temperature of the battery may be set to a temperature value to secure durability while suppressing an increase in the internal resistance of the battery 210. For example, the target temperature of the battery may be set to about 20° C.

When the temperature of the battery 210 is higher than the target temperature of the battery, it may be determined that raising the temperature of the battery 210 is unnecessary. Accordingly, the controller 400 does not perform temperature control of the battery 210 using the stack cooling water.

When the temperature of the battery 210 is lower than the target temperature of the battery, it may be determined that raising the temperature of the battery 210 is necessary. At this time, in order to determine whether the stack cooling water may be used as a heat source for raising the temperature of the battery 210 in step S20, the controller 400 compares the temperature of the stack cooling water with the temperature of the battery 210. Here, the temperature of the stack cooling water is a real-time temperature measured by the first temperature sensor 160.

When the temperature of the stack cooling water is lower than the temperature of the battery 210 in the step S20, it may be determined that the battery 210 may not be heated using the stack cooling water. In addition, when the temperature of the stack cooling water is lower than the temperature of the battery 210, the controller 400 may determine that the stack cooling water is being heated and may wait until the temperature of the stack cooling water becomes higher than the temperature of the battery 210 (e.g., before heating the battery with the stack cooling water).

In more detail, when the temperature of the stack cooling water is lower than the temperature of the battery 210 at the step S20, the controller 400 may determine that the vehicle is in an initial startup state and may wait until the temperature of the stack cooling water becomes higher than the temperature of the battery 210. When the temperature of the battery 210 is lower than the target temperature of the battery, and at the same time, the temperature of the stack cooling water is lower than the temperature of the battery 210, it may be determined that the vehicle is in the initial startup state and the stack cooling water is being heated.

The target temperature of the stack cooling water at vehicle startup is set to about 60° C., and the stack cooling water temperature during initial startup is similar to the outside temperature. Therefore, when the vehicle starts up, the COD heater 120 and the like may be operated to raise the temperature of the stack cooling water. When the stack cooling water passes through the chiller 220 during vehicle startup to exchange heat with the battery cooling water, the battery 210 may instead be cooled.

Therefore, when the temperature of the battery 210 is lower than the target temperature of the battery, and at the same time, the temperature of the stack cooling water is not greater than the temperature of the battery 210, the controller 400 may determine that the stack cooling water is being heated to the target temperature of the stack cooling water and waits until the temperature of the stack cooling water becomes higher than the temperature of the battery 210.

When the temperature of the stack cooling water is lower than the temperature of the battery 210, the controller 400 may control the first port 131 of the temperature control valve 130 to the closed mode (e.g., to be closed) or control the opening amount of the first port 131 to be the minimum value until just before the temperature of the stack cooling water becomes higher than the temperature of the battery 210. When the first port 131 of the temperature control valve 130 is in a closed mode, the stack cooling water does not pass through the chiller 220 and does not exchange heat with the battery cooling water.

When the temperature of the stack cooling water becomes higher than the temperature of the battery 210 in step S20, it may be determined that the stack cooling water may be used as a heat source for the battery 210. In this case, the controller 400 may vary the opening amount of the temperature control valve 130, thereby allowing relatively high-temperature stack cooling water to pass through the chiller 220.

In other words, when the temperature of the stack cooling water exceeds the temperature of the battery 210, the controller 400 may control the first port 131 of the temperature control valve 130 to an open mode (e.g. to be open).

At this time, in order to raise the temperature of the battery 210 to the target temperature of the battery, the opening amount of the temperature control valve 130 may be variably controlled on the basis of the magnitude of the differences between the temperature of the battery 210 and the target temperature of battery. Specifically, the controller 400 may determine and control the opening amount or opening degree of the first port 131 of the temperature control valve 130 in proportion to the magnitude of the difference between the temperature of the battery 210 and the target temperature of the battery in step S30. As the magnitude of the difference increases, the opening amount of the first port 131 may increase, and as the magnitude of the difference value decreases, the opening amount of the first port 131 may decrease. As the opening amount of the first port 131 increases, the flow rate of the stack cooling water passing through the chiller 220 may increase, and heat exchange between the stack cooling water and the battery cooling water is promoted (e.g., performed). As a result, the temperature-raising effect of the battery cooling water may be increased.

In addition, at this time, the fifth port 135 of the temperature control valve 130 connected to the first radiator 150 may be controlled so as to be in a closed mode, or its opening amount may be reduced.

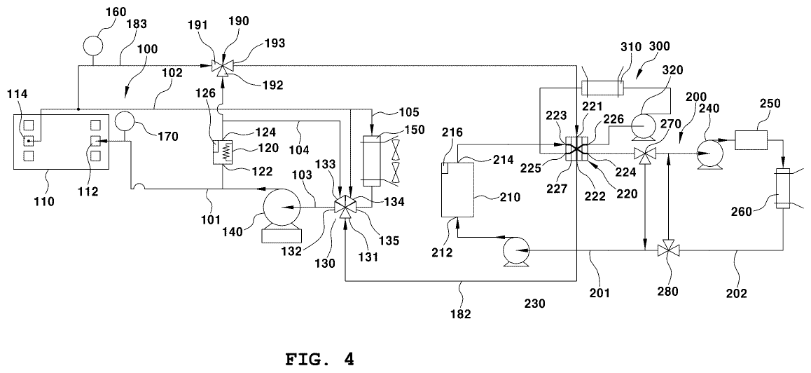

The accompanying FIG. 4 is a diagram illustrating a thermal management system of a fuel cell vehicle according to another embodiment of the present disclosure.

As illustrated in FIG. 4, the thermal management system according to another embodiment of the present disclosure further includes a third three-way valve 190 and a third cooling water branch line 183 compared to the thermal management system according to the previously described embodiment.

The third cooling water branch line 183 includes a first end branched off and extending from the second stack cooling water line 102 and a second end connected to the first port 191 of the third three-way valve 190.

The third three-way valve 190 is installed in or along the first cooling water branch line 181. The third three-way valve 190 includes a first port 191, a second port 192 connected to the cooling water outlet 124 of the COD heater 120, and a third port 193 connected to the first cooling water inlet 221 of the chiller 220.

The thermal management system of the present disclosure further includes the third cooling water branch line 183 and the third three-way valve 190, thereby allowing either one of the stack cooling water that has passed through the COD heater 120 (e.g.,, the first stack cooling water, first flow of stack cooling water) and the stack cooling water that has been discharged from the fuel cell stack 110 (e.g., the second stack cooling water, second flow of stack cooling water) to pass through the chiller 220.

In addition, both the first stack cooling water and the second stack cooling water may be supplied to and passed through the chiller 220. At this time, the mixing ratio of the first stack cooling water and the second stack cooling water may be determined by controlling the opening amount or degree of the first port 191 and the third port 193 of the third three-way valve 190.

The COD heater 120 may have a built-in fourth temperature sensor 126 for measuring the temperature of the stack cooling water discharged from the COD heater 120. A signal regarding the temperature of the first stack cooling water measured through the fourth temperature sensor 126 may be transmitted to the controller 400.

For example, where the fuel cell stack 110 is heated up using the COD heater 120, such as during the initial temperature rise of the fuel cell stack 110 after initial vehicle startup, the temperature of the first stack cooling water may be higher than the temperature of the second stack cooling water. Accordingly, by closing the first port 191 of the third three-way valve 190 and opening the second port 192 and the third port 193, the first stack cooling water at a higher temperature may be passed through the chiller 220, thereby allowing the battery 210 to be heated up more quickly.

In addition, by adjusting the opening amounts or degrees of the first port 191 and the third port 193 of the third three-way valve 190, the mixing amount or ratio of the first stack cooling water and the second stack cooling water may be controlled, and through this, the stack cooling water mixed at a desired temperature may be passed through the chiller 220.

In this way, the controller 400 may supply either one or both of the stack cooling water discharged from the fuel cell stack 110 and the stack cooling water discharged from the COD heater 120 to the first cooling water inlet 221 of the chiller 220 by controlling the opening amounts of the first port 191 and the third port 193 of the third three-way valve 190.

Meanwhile, in summer when the outside temperature is high, heat exchange may be performed between the battery cooling water and the refrigerant of the refrigerant circuit 300 through the chiller 220. At this time, the refrigerant of refrigerant circuit 300 is at a relatively lower temperature than the battery cooling water and cools the battery cooling water through heat exchange with the battery cooling water in the chiller 220. The battery cooling water cools the battery 210 while passing through the battery 210.

The embodiments of the present disclosure have been described in detail above, and the terms used in this specification and claims should not be interpreted as limited to their usual or dictionary meanings. In addition, the scope of the rights of the present disclosure is not limited to the embodiments described above. Various modifications and improvements made by those of ordinary skill in the art using the basic concept of the present disclosure defined in the claims below are also included in the scope of the rights of the present disclosure.

What is claimed is:

1. A thermal management system for a fuel cell vehicle, the thermal management system comprising:
a first thermal management circuit, including an electric heater, for raising a temperature of stack cooling water supplied to a fuel cell stack;
a second thermal management circuit including a chiller configured to facilitate heat exchange with battery cooling water supplied to a battery;
a first cooling water branch line connecting a cooling water outlet of the electric heater and a first cooling water inlet of the chiller; and
a second cooling water branch line including:
a first end connected to a first cooling water outlet of the chiller, and
a second end connected to the first thermal management circuit, wherein the second cooling water branch line is configured to supply stack cooling water discharged from the first cooling water outlet of the chiller to an upstream side of the electric heater.

2. The thermal management system of claim 1, wherein the first thermal management circuit comprises:
a temperature control valve disposed upstream of the electric heater,
wherein the temperature control valve is configured to receive the stack cooling water discharged from the first cooling water outlet of the chiller through the second cooling water branch line, and discharge it toward a cooling water inlet of the electric heater.

3. The thermal management system of claim 2, wherein the temperature control valve comprises:
a first port connected to the second end of the second cooling water branch line; and
a second port connected to the cooling water inlet of the electric heater,
wherein an opening amount of the first port of the temperature control valve is determined by a controller based on a difference between a temperature of the battery and a set target temperature of the battery.

4. The thermal management system of claim 3, wherein, based on the temperature of the stack cooling water discharged from the fuel cell stack being higher than the temperature of the battery, the controller is configured to determine the opening amount of the first port of the temperature control valve based on the difference between the temperature of the battery and the target temperature of the battery.

5. The thermal management system of claim 4, wherein the controller is configured to determine the opening amount of the first port of the temperature control valve proportionally to a magnitude of the difference between the temperature of the battery and the target temperature of the battery.

6. The thermal management system of claim 3, wherein, based on the temperature of the battery being lower than the target temperature of the battery, and the temperature of the stack cooling water discharged from the fuel cell stack being equal to or lower than the temperature of the battery, the controller is configured to control the first port of the temperature control valve to be in a closed mode until just before the temperature of the stack cooling water discharged from the fuel cell stack becomes higher than the temperature of the battery.

7. The thermal management system of claim 6, wherein, based on the temperature of the battery being lower than the target temperature of the battery, and the temperature of the stack cooling water discharged from the fuel cell stack being higher than the temperature of the battery, the controller is configured to control the first port of the temperature control valve to be in an open mode.

8. The thermal management system of claim 3, wherein the temperature control valve further comprises:
a third port connected to a cooling water outlet of the electric heater through a first stack cooling water line; and
a fourth port connected to a cooling water outlet of the fuel cell stack through a second stack cooling water line.

9. The thermal management system of claim 1, wherein the chiller comprises:
a second cooling water inlet connected to a cooling water outlet of the battery;
a second cooling water outlet connected to a cooling water inlet of the battery; and
a chiller body configured to facilitate heat exchange between the battery cooling water introduced through a second cooling water inlet of the chiller and the stack cooling water introduced through the first cooling water inlet of the chiller.

10. The thermal management system of claim 8, wherein the first cooling water branch line is installed with a three-way valve,
wherein the three-way valve comprises:
a first port connected to a third cooling water branch line branched off from the second stack cooling water line;
a second port connected to the cooling water outlet of the electric heater; and
a third port connected to the first cooling water inlet of the chiller.

11. The thermal management system of claim 10, wherein the controller is configured to supply either one or both of the stack cooling water discharged from the fuel cell stack and the stack cooling water discharged from the electric heater to the first cooling water inlet of the chiller by controlling the opening amounts of the first port and the third port of the three-way valve.

12. A thermal management system for a fuel cell vehicle, the thermal management system comprising:
a first thermal management circuit including an electric heater configured to increase a temperature of stack cooling water supplied to a fuel cell stack;
a second thermal management circuit including a chiller configured to facilitate heat exchange with battery cooling water supplied to a battery;
a first cooling water branch line connecting a cooling water outlet of the electric heater and a first cooling water inlet of the chiller; and
a second cooling water branch line provided with a first end connected to a first cooling water outlet of the chiller and a second end connected to the first thermal management circuit, the second cooling water branch line configured to supply stack cooling water discharged from the chiller to an upstream side of the electric heater.

13. The thermal management system of claim 12, wherein the first thermal management circuit includes a temperature control valve disposed upstream of the electric heater, the temperature control valve configured to receive the stack cooling water discharged from the chiller.

14. The thermal management system of claim 13, wherein the temperature control valve is a five way valve.

15. The thermal management system of claim 13, wherein
the temperature control valve comprises:
a first port connected to the second end of the second cooling water branch line; and
a second port connected to the cooling water inlet of the electric heater,
wherein an opening amount of the first port of the temperature control valve is determined by a controller based on a difference between a temperature of the battery and a set target temperature of the battery.

16. The thermal management system of claim 12, wherein
the chiller comprises:
a second cooling water inlet connected to a cooling water outlet of the battery;
a second cooling water outlet connected to a cooling water inlet of the battery; and
a chiller body configured to facilitate heat exchange between the battery cooling water introduced through a second cooling water inlet of the chiller and the stack cooling water introduced through the first cooling water inlet of the chiller.

17. A thermal management system for a fuel cell vehicle, the thermal management system comprising:
a first thermal management circuit including an electric heater configured to increase a temperature of stack cooling water supplied to a fuel cell stack;
a second thermal management circuit including a chiller configured to facilitate heat exchange with battery cooling water supplied to a battery;
a first cooling water branch line connecting the electric heater and the chiller; and
a second cooling water branch line provided with a first end connected to the chiller and a second end connected to the first thermal management circuit, the second cooling water branch line configured to supply stack cooling water discharged from the chiller to an upstream side of the electric heater.

18. The thermal management system of claim 17, wherein the first thermal management circuit includes a temperature control valve disposed upstream of the electric heater, the temperature control valve configured to receive the stack cooling water discharged from the chiller.

19. The thermal management system of claim 18, wherein the temperature control valve is a five way valve.

20. The thermal management system of claim 18, wherein
the temperature control valve comprises:
a first port connected to the second cooling water branch line; and
a second port connected to a cooling water inlet of the electric heater,
wherein an opening amount of the first port of the temperature control valve is determined by a controller based on a difference between a temperature of the battery and a set target temperature of the battery.
